(19) United States
(12) Patent Application Publication
(10) Pub. No.: US 2015/0099396 A1
(43) Pub. Date: Apr. 9, 2015

(54) CONNECTOR

(71) Applicant: YAZAKI CORPORATION, Tokyo (JP)

(72) Inventors: Shigeo Mori, Kakegawa-shi (JP); Masayuki Kataoka, Kakegawa-shi (JP); Fuminori Sugiyama, Kakegawa-shi (JP); Yoshitaka Koda, Kakegawa-shi (JP)

(73) Assignee: YAZAKI CORPORATION, Tokyo (JP)

(21) Appl. No.: 14/403,656

(22) PCT Filed: Jun. 26, 2013
(86) PCT No.: PCT/JP2013/067468

§ 371 Date: Nov. 25, 2014

(30) Foreign Application Priority Data
Jun. 26, 2012 (JP) 2012-143453

(51) Int. Cl. H01R 13/58; H01R 24/28

(52) U.S. Cl. CPC H01R 13/5845; H01R 24/28
USPC 439/606

(57) ABSTRACT

A connector (11) includes terminals (17) to which distal end portions (19) of covered electric wires (13) are fixed, a sealing portion (23) integrally covering respective adjacent portions (27) of the terminals (17) and coverings (21) of the covered electric wires (13) that are provided side by side, and a housing (25) integrally covering around the sealing portion (23). An injection gate mark (47) produced due to an injection molding of an insulative resin is formed on a coupling portion (49) of the housing (25).

### TECHNICAL FIELD

The present invention relates to a connector.

### BACKGROUND ART

In the related art, a shield connector (see Patent Document 1), in which an insulative resin housing covers an outer circumferential side of a waterproof cylindrical section made of a urethane resin, which covers an electric wire, and a connector (see Patent Document 2), in which an elastic sealing member is formed integrally with an electric wire and an electric wire protection portion of a connector housing formed of an insulative synthetic resin, are known. In the connector disclosed in Patent Document 2, the connector housing is formed of the synthetic resin around a terminal fixture and a distal end of an electric wire by using a mold such that the electric wire connection portion and the distal end of the electric wire are integrally formed. Therefore, it is possible to cause connection positions between the electric wire connection portion of the terminal fixture and the electric wire to be unlikely to be separated from each other, without increasing the number of components.

In addition, the sealing member is provided so as to cover a boundary portion between the connector housing and the electric wire, and the inner surface of the connector housing is water-tightly protected against the outer surface of the electric wire. Therefore, the sealing member can prevent a liquid, such as water, from infiltrating to the connector housing along the electric wire.

The sealing member is formed of a primary molding resin that is molded primarily before the connector housing is molded secondarily using a secondary molding resin. Since the primary molding resin is molded along the curve of the electric wire, an elastic material, such as rubber, which has a higher flexibility than the secondary molding resin, is selected.

### PRIOR ART DOCUMENTS

### Patent documents

Patent Document 1: JP 2003-272779 A

Patent Document 2: JP 2011-154864 A

### SUMMARY OF INVENTION

### Problem to be Solved by Invention

However, in the connector that includes the waterproof cylindrical section or the sealing member described above, the primary molding resin having the flexibility can be strained during the secondary molding in mold-forming. In one reference example (connector 501) of this type of connector illustrated in FIGS. 4 and 5, a sealing member 507 is, first, mold-formed on an outer circumferential surface of an electric wire 505 in which a conductor is connected to a terminal 503, using a synthetic resin (primary molding resin) (see FIG. 5). Then, a housing 509 is molded over the outer circumferential side of the sealing member 507 using a synthetic resin (secondary molding resin) that is harder than the sealing member 507, thereby forming the connector 501 (see FIG. 4). As illustrated in FIG. 6, during the secondary molding in which the primary-molded sealing member 507 is disposed inside a cavity 510 of an injection molding die 511, a primary molding resin that has been molded is disposed at a position facing a gate 513 through which the secondary molding resin is injected. Therefore, during the secondary resin molding, strain 8 is produced in the primary molding resin which is pressed with pressure P due to a resin flow of the secondary molding resin. As a result, during the secondary resin molding, the primary-molded sealing member 507 is strained, and thus there is a possibility of an occurrence of a molding defect, such as peeling off of the primary molding resin from the outer circumferential surface of the electric wire 505 or leakage of the secondary molding resin that has been melted from the injection molding die 511.

The present invention has been made in view of the above situations, and an object thereof is to provide a connector which can reduce an occurrence of a molding defect during a secondary molding in mold-forming. Means for Solving the Problem

The above object according to the present invention is achieved by the following configurations.

(1) A connector including terminals to which conductors exposed at distal end portions of covered electric wires are fixed, a sealing portion formed of an insulative and elastic material to integrally cover respective adjacent portions of the terminals and coverings of the covered electric wires that are provided side by side, and a housing formed of an insulative resin having higher rigidity than the elastic material to integrally cover around the sealing portion at the distal end portions of the covered electric wires, in which an injection gate mark produced due to an injection molding of the insulative resin is formed on a coupling portion of the housing, the coupling portion being injection-molded in a separating section formed between the distal end portions of the covered electric wires that are provided side by side and each covered by the sealing portion.

According to the connector having the configuration of (1) described above, the sealing portion formed of the insulative and elastic material is not provided at a position facing the injection gate for the insulative resin during the secondary molding in which the housing is molded. Therefore, a resin flow during the injection (secondary molding) of the insulative resin does not have a direct influence on the sealing portion formed of the elastic material. Accordingly, since an influence of the resin flow of the secondary molding resin on a primary molding resin (sealing portion) is reduced, it is unlikely for the sealing portion to be peeled off from the outer circumferential surfaces of the electric wires or for the insulative resin melted from the injection molding die to be leaked. In addition, since the position facing the injection gate during the secondary molding becomes the separating section formed between the distal end portions of the covered electric wires that are arranged side-by-side, fluidity of the insulative resin as the secondary molding resin is improved inside the cavity, thus it is possible to set a high injection rate or stable pressure keeping of the insulative resin, and it is possible to increase flexibility in a product shape and a mold structure, and simultaneously contribute to the reduction of a defect ratio of the product.

(2) In the connector having the configuration according to (1) described above, the sealing portion is formed with a boot portion to cover the covered electric wires on a side opposite to a side to which the terminals are connected, and a flange is formed between the separating section and the boot portion, the flange having a greater outer diameter than the boot portion and being covered by the housing.

According to the connector having the configuration of (2) described above, the flange covered by the housing is formed in the sealing portion, between the separating section and the boot portion. Thus, even when tensile force acts on the boot portion during attachment or detachment of the connector, the flange covered by the housing functions as a strain relief portion, and thus the tensile force does not directly influence the terminals. As a result, a waterproof condition between the terminals and the sealing portion is maintained satisfactorily.

The present invention has been briefly described above. Details of the present invention will be further apparent by going through the following description of embodiments for carrying out the invention (hereinafter, “embodiments”) with reference to the accompanying drawings.

### BRIEF DESCRIPTION OF DRAWINGS

FIG. 1 is a plan view of a connector according to an embodiment of the present invention;

FIG. 2 is a plan view of the connector illustrated in FIG. 1 without a housing;

FIG. 3 is a transverse cross-sectional view of an injection molding die in which the housing illustrated in FIG. 1 is molded;

FIG. 4 is a plan view of a reference example of the connector;

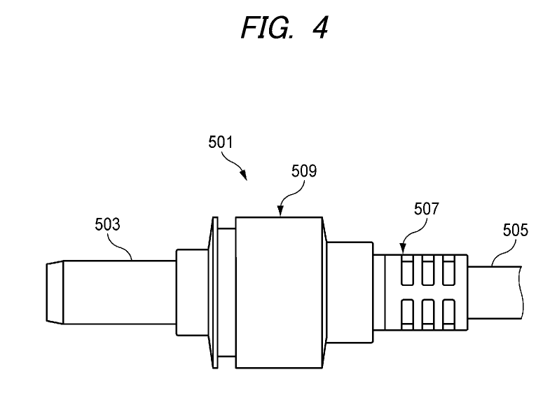

FIG. 5 is a plan view of the connector illustrated in FIG. 4 without a housing; and

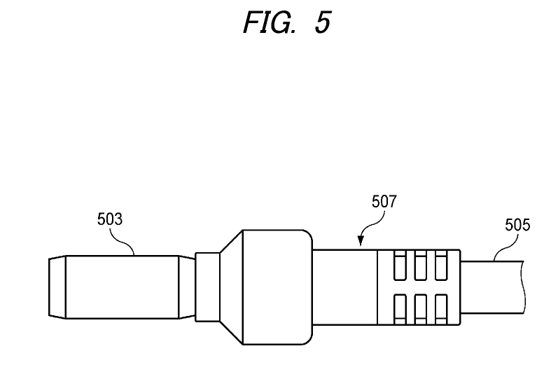

FIG. 6 is a longitudinal cross-sectional view of an injection molding die in which the housing illustrated in FIG. 4 is molded.

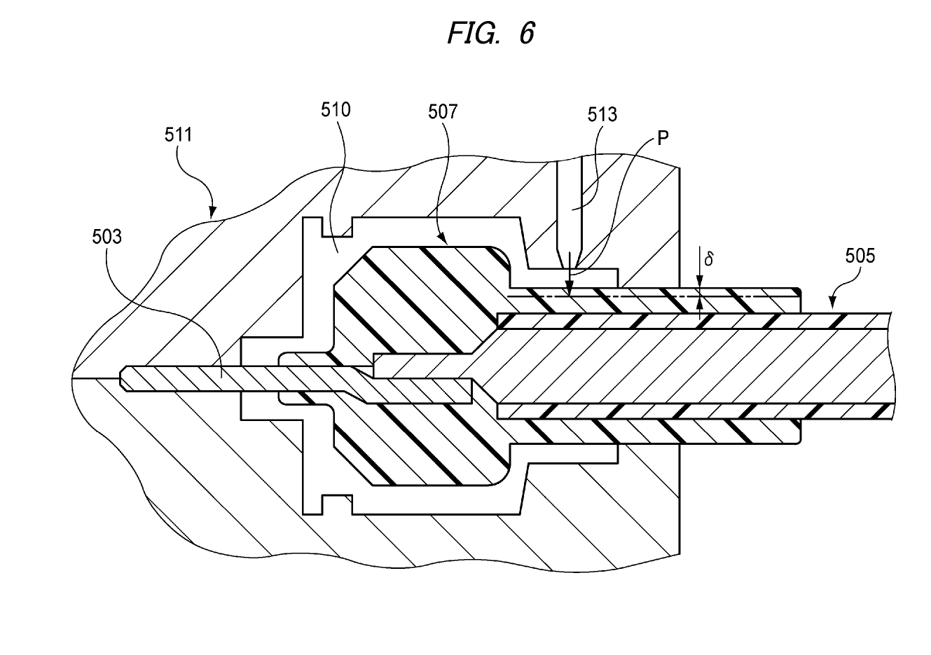

### EMBODIMENTS OF INVENTION

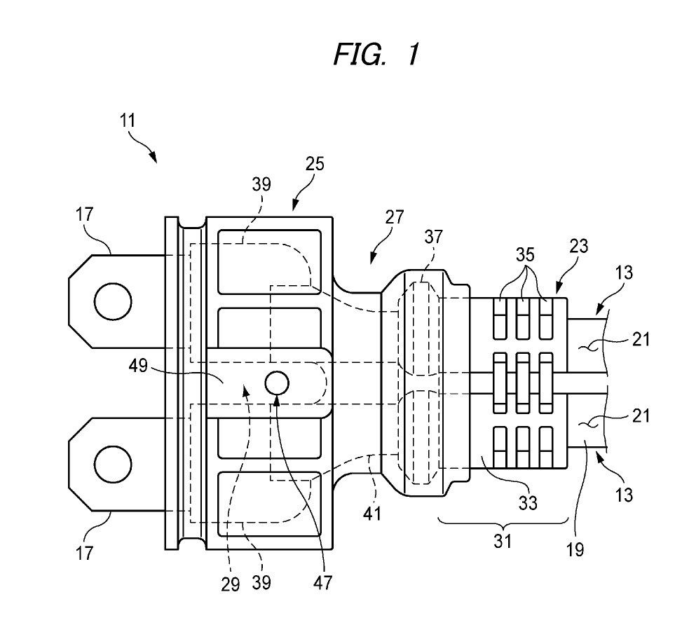

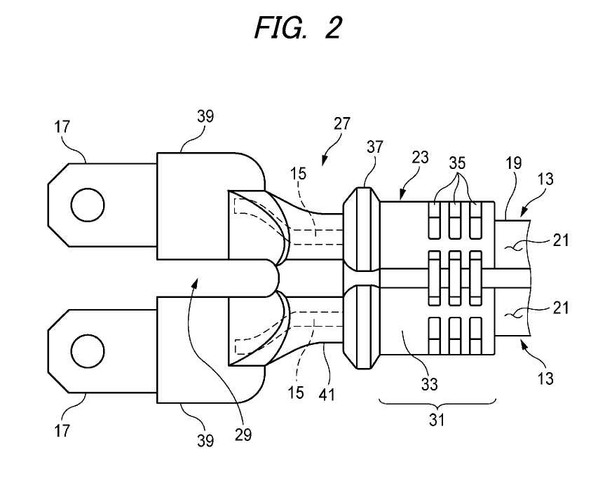

Hereinafter, embodiments according to the present invention will be described with reference to the drawings. As illustrated in FIGS. 1 and 2, a connector 11 according to the present embodiment is a so-called over-molded connector in which a terminal 17 is connected to a conductor 15 of a covered electric wire 13, thus forming a connection portion of a distal end portion 19 of the covered electric wire 13 and a part of the terminal 17, and the connection portion is covered with a resin-molded product.

In the connector 11 according to the present embodiment, the covered electric wire 13 in which the conductor 15 is covered by a covering 21 is used. The covered electric wire according to the present invention may be a shield electric wire in which an outer side of an inner insulation covering that covers a conductor is covered with a conductive metal braid of which an outer side is covered with an outer covering, other than the covered electric wire 13 in which the conductor 15 is covered only with the covering 21. In addition, in the connector 11 according to the present embodiment, the terminals 17 are each connected to the conductor 15 and are each provided with respect to a plurality (two in the present embodiment) of covered electric wires 13 provided side by side.

The terminal 17 is connected and fixed to the conductor 15 exposed at the distal end portion 19 of the covered electric wire 13. A connection structure between the terminal 17 and the conductor 15 may be any one of a pressure bonding structure, a pressure welding structure, a welding structure, a brazing structure, and the like. In addition, in the present embodiment, the terminal 17 is illustrated as a flat terminal that is a male terminal, but the terminal 17 may be a female terminal having a box-like electrical contact portion in addition to a ring terminal, a Y-shaped terminal, or the like.

The connector 11 is formed such that the conductors 15 and distal end portions 19 of the covered electric wires 13 are molded primarily as a sealing portion 23 by using an insulative and elastic member, such as a thermoplastic elastomer, or the like, and then these sealing portions 23 and distal end portions 19 are molded secondarily as a housing 25 by using an insulative resin, such as a thermoplastic resin. The sealing portion 23 is formed of the thermoplastic elastomer and covers integrally respective adjacent portions 27 of the two terminals 17 and the coverings 21 of the two covered electric wires 13 which are provided side by side. A separating section 29 is formed between the two terminals 17 provided side by side in the sealing portion 23.

The housing 25 is formed of an insulative resin that is higher in rigidity than the elastic material that forms the sealing portion 23. The housing 25 covers integrally around the sealing portion 23 on the distal end portion 19 of the covered electric wire 13. A boot portion 31, which covers the covered electric wire 13 on the side opposite to the side to which the terminal 17 is connected, is formed in the sealing portion 23. The boot portion 31 has a protection portion 33 that covers the outer circumference of the covered electric wire 13. A plurality of circumferential grooves 35 for imparting appropriate flexibility to the protection portion 33 are formed around the protection portion 33. A flange 37 that is formed to have a greater outer diameter than the boot portion 31 and is covered by the housing 25 is formed between the separating section 29 and the boot portion 31 of the sealing portion 23.

As shown in FIG. 2, the sealing portion 23 has a pair of terminal molded portions 39 that covers a part of each terminal 17 interposing the separating section 29 therebetween. That is, the pair of terminal molded portions 39 is separated by the separating section 29. A constricted portion 41 that has a smaller outer diameter than the terminal molded portions 39 and the flange 37 is formed in the sealing portion 23 between the terminal molded portions 39 and the flange 37. As a result, a Y shape in which the constricted portion 41 branches into two terminal molded portions 39 interposing the separating section 29 therebetween is formed on the terminal 17 side of the sealing portion 23.

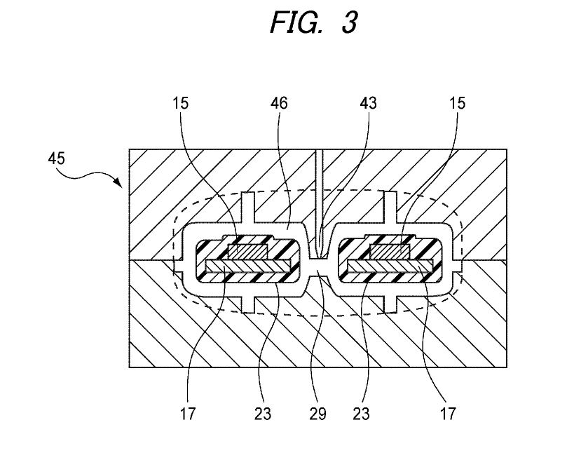

When the above-described connector 11 is manufactured, first, the covered electric wire 13 in which the terminals 17 are fixed to the conductors 15 is set in a primary molding die (not illustrated) and the sealing portion 23 illustrated in FIG. 2 is formed through primary molding. A shape of the sealing portion 23 in the primary molding is formed taking into account a position of an injection gate 43 (see FIG. 3) during secondary molding. That is, a structure is employed, in which the separating section 29 that is an avoidance space from a secondary molding injection resin is disposed at a portion positioned to face the injection gate 43 during the secondary molding, and a resin flow does not directly influence the sealing portion 23.

After the sealing portion 23 is formed in the primary molding, the covered electric wire 13 having the sealing portion 23 is inserted into a cavity 46 of a secondary molding die (injection molding die) 45 illustrated in FIG. 3, the secondary molding is performed by using the insulative resin, and the housing 25 is mold-formed. That is, the sealing portion 23 is formed of the thermoplastic elastomer that is the elastic material, and the housing 25 is formed of the thermoplastic resin that is the insulative resin.

Here, the injection gate mark 47 (see FIG. 1) produced by injection molding of the insulative resin is formed on a coupling portion 49 of the housing 25 molded by using injection of the insulative resin in the separating section 29 formed between the side-by-side provided distal end portions 19 of the covered electric wires 13 that are covered with the sealing portion 23 formed of the elastic material. That is, the insulative resin melted from the injection gate 43 is injected into the separating section 29 of the sealing portion 23 inserted into the secondary molding die 45. As a result, the insulative resin to be injected does not come into direct contact with the sealing portion 23 formed of the elastic material.

Next, effects of the connector 11 having the above configurations will be described. In the above-described connector 11, the sealing portion 23 formed of the thermoplastic elastomer that is the elastic material is not disposed at a position facing the injection gate 43 of the insulative resin during the secondary molding in which the housing 25 is molded. Thus, the resin flow during injection (during the secondary molding) of the insulative resin does not directly influence the sealing portion 23 formed of the thermoplastic elastomer.

Accordingly, since the influence of the resin flow of a secondary molding resin on a primary molding resin (sealing portion 23) is decreased, it is unlikely for the sealing portion 23 to be peeled off from an outer circumferential surface of the covered electric wire 13 or for the insulative resin melted from the inside of the cavity 46 of the secondary molding die 45 to be leaked. In addition, since the position facing the injection gate 43 during the secondary molding becomes the separating section 29 formed between the distal end portion 19 of the covered electric wires 13 arranged side-by-side, the fluidity of the insulative resin that is the secondary molding resin is improved inside the cavity 46, thus it is possible to set a high injection rate or stable pressure keeping of the insulative resin, and it is possible to increase a flexibility in a product shape and a mold structure, and simultaneously contribute to the reduction of a defect ratio of the product.

In addition, in the above-described connector 11, the flange 37 covered by the housing 25 is formed between the separating section 29 and the boot portion 31 in the sealing portion 23. Thus, even when tensile force acts on the boot portion 31 during attachment or detachment of the connector, the flange 37 covered by the housing 25 functions as a strain relief portion, and thus the tensile force does not directly influence the terminal 17. As a result, a waterproof condition between the terminals 17 and the sealing portion 23 is maintained satisfactorily.

In the connector 11 according to the present embodiment, it is possible to decrease an occurrence of a molding defect during the secondary molding in mold-forming.

Here, features of the embodiments of the connector according to the present invention described above are briefly summarized as follows.
[1] The connector 11 includes the terminals 17 to which the conductors 15 exposed at the distal end portions 19 of the covered electric wires 13 are fixed, the sealing portion 23 formed of the insulative and elastic material to integrally cover the respective adjacent portions of the terminals 17 and the coverings 21 of the covered electric wires 13 that are provided side by side, and the housing 25 formed of the insulative resin having higher rigidity than the elastic material to integrally cover around the sealing portion 23 on the distal end portions 19 of the covered electric wires 13, in which the injection gate mark 47 produced due to the injection molding of the insulative resin is formed on the coupling portion 49 of the housing 25, the coupling portion 49 being injection-molded in the separating section 29 formed between the distal end portions 19 of the covered electric wires 13 that are provided side by side and each covered by the sealing portion 23.
[2] The connector 11 according to [1] described above, in which the sealing portion 23 is formed with the boot portion 31 to cover the covered electric wires 13 on the side opposite to the side to which the terminals 17 are connected, and the flange 37 is formed between the separating section 29 and the boot portion 31, the flange 37 having a greater outer diameter than the boot portion 31 and being covered by the housing 25.

The connector according to the present invention is not limited to the embodiments above described, and various changes and mopdifications can be made therein as appropriate.

In addition, the material, shape, size, number, location, and the like of each component according to the above described embodiments is not limited, and are optional in so far as the present invention can be implemented. The present application is based on Japanese Patent Application No. 2012-143453 filed Jun. 26, 2012, the content of which is incorporated herein by reference.

### INDUSTRIAL APPLICABILITY

With a connector according to the present invention, it is possible to decrease an occurrence of a molding defect during secondary molding in mold-forming.

### EXPLANATION OF REFERENCE SIGNS

11 . . . connector

13 . . . covered electric wire

15 . . . conductor

17 . . . terminal

19 . . . distal end portion

21 . . . covering

23 . . . sealing portion

25 . . . housing

27 . . . adjacent portion

29 . . . separating section

43 . . . injection gate

45 . . . secondary molding die (injection molding die)

47 . . . injection gate mark

49 . . . coupling portion

1. A connector comprising:
terminals to which conductors exposed at distal end portions of covered electric wires are fixed;
a sealing portion formed of an insulative and elastic material to integrally cover respective adjacent portions of the terminals and coverings of the covered electric wires that are provided side by side; and
a housing formed of an insulative resin having higher rigidity than the elastic material to integrally cover around the sealing portion at the distal end portions of the covered electric wires,
wherein an injection gate mark produced due to an injection molding of the insulative resin is formed on a coupling portion of the housing, the coupling portion being injection-molded in a separating section formed between the distal end portions of the covered electric wires that are provided side by side and each covered by the sealing portion.

2. The connector according to claim 1,
wherein the sealing portion is formed with a boot portion to cover the covered electric wires on a side opposite to a side to which the terminals are connected, and
wherein a flange is formed between the separating section and the boot portion, the flange having a greater outer diameter than the boot portion and being covered by the housing.
